(19) United States
(12) Patent Application Publication
(10) Pub. No.: US 2010/0238520 A1
(43) Pub. Date: Sep. 23, 2010

(54) ERECTING EQUAL-MAGNIFICATION LENS ARRAY PLATE, OPTICAL SCANNING UNIT, AND IMAGE READING DEVICE

(75) Inventor: Hideshi NAGATA, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: Nippon Sheet Glass Company, Limited, Tokyo (JP)

(21) Appl. No.: 12/728,529

(22) Filed: Mar. 22, 2010

(30) Foreign Application Priority Data
Mar. 23, 2009 (JP) 2009-070699

(51) Int. Cl. H04N 1/04; G02B 27/12

(52) U.S. Cl. 358/475; 359/622

(57) ABSTRACT

An erecting equal-magnification lens array plate includes: a first lens array plate provided with a plurality of first lenses arranged systematically on a first surface of the plate and with a plurality of second lenses arranged systematically on a second surface opposite to the first surface; and a second lens array plate provided with a plurality of third lenses arranged systematically on a third surface of the plate and with a plurality of fourth lenses arranged systematically on a fourth surface opposite to the third surface. The first lens array plate and the second lens array plate form a stack such that the second surface and the third surface face each other to ensure that a combination of the lenses associated with each other form a coaxial lens system, the plate receiving light from a document G facing the first surface and forming an erect equal-magnification image of the document G on an image plane facing the fourth surface. The second lenses are arranged so as to create no gaps between adjacent lenses.

### BACKGROUND OF THE INVENTION

1. Field of the Invention

The present invention relates to erecting equal-magnification lens array plates used in image reading devices and image forming devices and to optical scanning units and image reading devices using the erecting equal-magnification lens array plate.

2. Description of the Related Art

Some image reading devices such as scanners are known to use erecting equal-magnification optics. Erecting equal-magnification optics are capable of reducing the size of devices better than reduction optics. In the case of image reading devices, an erecting equal-magnification optical system comprises a line light source, an erecting equal-magnification lens array, and a line image sensor.

A rod lens array capable of forming an erect equal-magnification image is used as an erecting equal-magnification lens array in an erecting equal-magnification optical system. Normally, a rod lens array comprises an array of rod lenses in the longitudinal direction (main scanning direction of the image reading device) of the lens array.

By increasing the number of columns of rod lenses, the proportion of light transmitted is improved and unevenness in the amount of light transmitted is reduced. Due to price concerns, it is common to use one or two columns of rod lenses in a rod lens array.

Meanwhile, an erecting equal-magnification lens array plate could be formed as a stack of a plurality of transparent lens array plates built such that the optical axes of individual convex lenses are aligned, where each transparent lens array plate includes a systematic arrangement of micro-convex lenses on one or both surfaces of the plate. Since an erecting equal-magnification lens array plate such as this can be formed by, for example, injection molding, erecting equal-magnification lens arrays in a plurality of columns can be manufactured at a relatively low cost (see, for example patent document No. 1).

[patent document No. 1] JP 2005-37891

An erecting equal-magnification lens array plate lacks a wall for beam separation between adjacent lenses.

Therefore, there is a problem of stray light wherein a light beam diagonally incident on an erecting equal-magnification lens array plate travels diagonally inside the plate and enters an adjacent convex lens, creating noise (also referred to as ghost) as it leaves the plate.

### SUMMARY OF THE INVENTION

In this background, a purpose of the present invention is to provide an erecting equal-magnification lens array plate capable of removing stray light suitably, and an optical scanning unit and an image reading device using the inventive erecting equal-magnification lens array plate.

In order to address the goal, the erecting equal-magnification lens array plate according to one embodiment of the present invention comprises: a first lens array plate provided with a plurality of first lenses arranged systematically on a first surface of the plate and with a plurality of second lenses arranged systematically on a second surface opposite to the first surface; and a second lens array plate provided with a plurality of third lenses arranged systematically on a third surface of the plate and with a plurality of fourth lenses arranged systematically on a fourth surface opposite to the third surface, wherein the first lens array plate and the second lens array plate form a stack such that the second surface and the third surface face each other to ensure that a combination of the lenses associated with each other form a coaxial lens system, the plate receiving light from a line light source facing the first surface and forming an erect equal-magnification image of the line light source on an image plane facing the fourth surface. The second lenses and/or the third lenses of the erecting equal-magnification lens array plate are arranged so as to create no gaps between adjacent lenses.

Since the second lenses and/or the third lenses according to the embodiment are formed so as to create no gaps between adjacent lenses, at least a part of the beam diagonally incident from the line image source on the first lens array plate is totally reflected or refracted at the boundary divisions of the second lenses and/or at the boundary divisions of the third lenses. Therefore, the beam is substantially prevented from being directly transmitted through the second lens array plate.

This prevents stray light from being incident on the image plane more successfully than in the case where a flat part is provided between the second lenses and between the third lenses.

The second lenses and/or the third lenses may be formed such that the lens diameter is equal to or more than the lens pitch. This results in the lenses being arranged such that the edges of the adjacent lenses are in contact with each other or overlap each other, eliminating any gaps. Thereby, stray light is suitably removed.

Another embodiment of the present invention also relates to an erecting equal-magnification lens array plate. The erecting equal-magnification lens array plate comprises: a first lens array plate provided with a plurality of first lenses arranged systematically on a first surface of the plate and with a plurality of second lenses arranged systematically on a second surface opposite to the first surface; and a second lens array plate provided with a plurality of third lenses arranged systematically on a third surface of the plate and with a plurality of fourth lenses arranged systematically on a fourth surface opposite to the third surface, wherein the first lens array plate and the second lens array plate form a stack such that the second surface and the third surface face each other to ensure that a combination of the lenses associated with each other form a coaxial lens system, the plate receiving light from a line light source facing the first surface and forming an erect equal-magnification image of the line light source on an image plane facing the fourth surface, wherein the second lenses and/or the third lenses are formed such that the ratio of the lens diameter with respect to the lens pitch is 0.95 or more.

The arrangement of the second lenses and/or the third lenses wherein the gaps between the adjacent lenses are extremely small is also useful to achieve an erecting equal-magnification lens array plate in which stray light is suitably removed.

A light shielding wall for removing stray light may be provided on the first and fourth surfaces. It is desirable that the height of the shielding wall be set to remove light entering at an angle larger than a predetermined maximum angle of view. In this case, stray light is more suitably removed.

Another embodiment of the present invention relates to an optical scanning unit. The optical scanning unit comprises: a line light source adapted to illuminate an image to be read; the above-described erecting equal-magnification lens array plate adapted to condense light reflected from the image to be read; and a line image sensor adapted to receive the light transmitted by the erecting equal-magnification lens array plate.

According to this embodiment, the line image sensor is capable of receiving an erect equal-magnification image with reduced noise because the optical scanning unit comprises the above described erecting equal-magnification lens array plate.

Yet another embodiment of the present invention relates to an image reading device. The device comprises: the above described optical scanning unit; and an image processing unit adapted to process an image signal detected by the optical scanning unit.

According to this embodiment, high-quality image data with reduced noise can be produced because the image reading device comprises the above-described optical scanning unit.

Optional combinations of the aforementioned constituting elements, and implementations of the invention in the form of methods, apparatuses, and systems may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows an image reading device according to an embodiment of the present invention;

FIG. 2 shows an erecting equal-magnification lens array plate according to the embodiment;

FIG. 3 is a top view showing the first surface of the first lens array plate;

FIG. 4 is a top view showing the second surface of the first lens array plate;

FIG. 5 shows the operation of the erecting equal-magnification lens array plate according to a comparative example;

FIG. 6 shows the operation of the erecting equal-magnification lens array plate according to the embodiment;

FIG. 7 shows an erecting equal-magnification lens array plate according to another embodiment of the present invention;

FIG. 8 shows an erecting equal-magnification lens array plate according to yet another embodiment of the present invention;

FIG. 9 shows how the noise ratio varies as the lens diameters of the lenses on the first through fourth surfaces are varied;

FIG. 10 shows how the noise ratio varies as the lens diameter is varied.

### DETAILED DESCRIPTION OF THE INVENTION

The invention will now be described by reference to the preferred embodiments. This does not intend to limit the scope of the present invention, but to exemplify the invention.

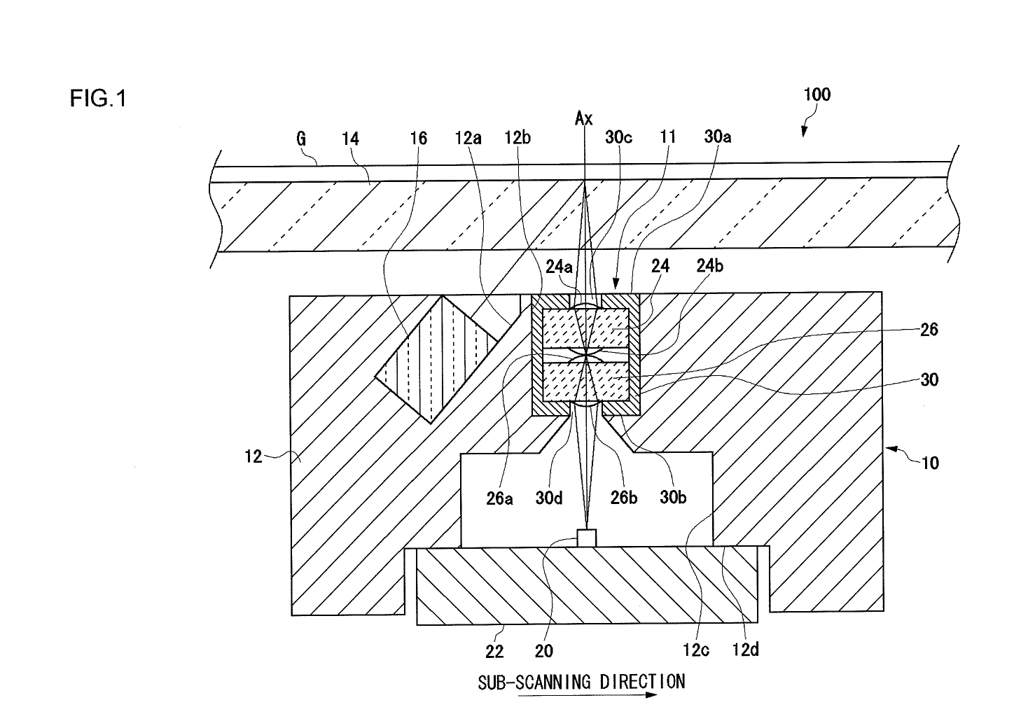

FIG. 1 shows an image reading device 100 according to an embodiment of the present invention. As shown in FIG. 1, the image reading device 100 comprises an optical scanning unit 10, a glass plate 14 on which a document G is placed, a driving mechanism (not shown) for scanning the optical scanning unit 10, and an image processing unit (not shown) for processing data read by the optical scanning unit 10.

The optical scanning unit 10 comprises a line light source 16 for illuminating a document G placed on a glass plate 14, an erecting equal-magnification lens array plate 11 for condensing light reflected from the document G, a line image sensor (photoelectric transducer) 20 for receiving light condensed by the erecting equal-magnification lens array plate 11, and a housing 12 for fixing the line light source 16, the erecting equal-magnification lens array plate 11, and the line image sensor 20.

The housing 12 is formed to be substantially cubic in shape. First and second recesses 12a and 12b are formed on top of the housing 12, and a third recess 12c is formed on the bottom thereof. The housing 12 is formed by, for example, injection molding. By forming the housing 12 by injection molding, the housing 12 can be formed easily and at a low cost. The line light source 16 is diagonally fixed inside the first recess 12a. The line light source 16 is fixed such that the optical axis of the illuminating light passes through the intersection between the optical axis Ax of the erecting equal-magnification lens array plate 11 and the top surface of the glass plate 14.

The erecting equal-magnification lens array plate 11 is secured in the second recess 12b. A substrate 22 provided with the line image sensor 20 is fitted in the third recess 12c. The substrate 22 is secured such that the top surface thereof is in contact with a step 12d provided in the third recess 12c.

The erecting equal-magnification lens array plate 11 comprises a stack of a first lens array plate 24 and a second lens array plate 26 built such that pairs of corresponding lenses form a coaxial lens system, where each lens array plate is formed with a plurality of convex lenses on both surfaces of the plate. The first lens array plate 24 and the second lens array plate 26 are held by a holder 30 in a stacked state. The erecting equal-magnification lens array plate 11 is installed in the image reading device 100 such that the longitudinal direction thereof is aligned with the main scanning direction and the lateral direction thereof is aligned with the sub-scanning direction.

The erecting equal-magnification lens array plate 11 is configured to receive substantially line light reflected from the document G located above and form an erect equal-magnification image on an image plane located below, i.e., a light-receiving surface of the line image sensor 20. The image reading device 100 is adapted to read the document G by scanning the optical scanning unit 10 in the sub-scanning direction.

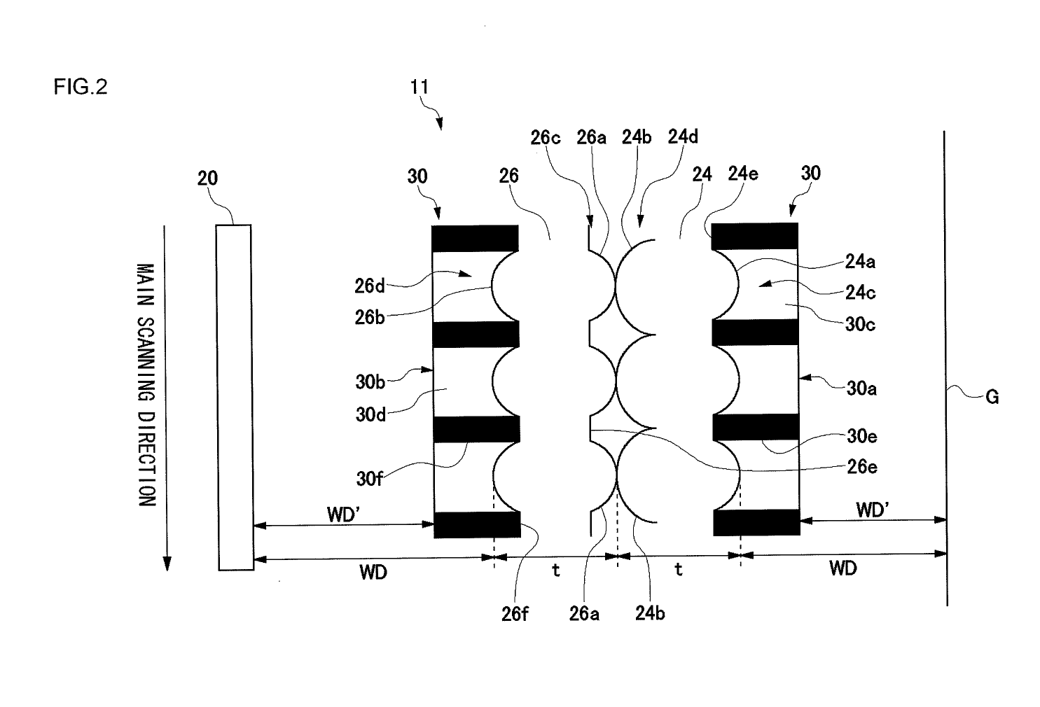

FIG. 2 shows the erecting equal-magnification lens array plate 11 according to the embodiment. FIG. 2 shows a partial cross section of the optical scanning unit 10 in the main scanning direction. Referring to FIG. 2, the vertical direction in the illustration represents main scanning direction (longitudinal direction) of the erecting equal-magnification lens array plate 11 and the depth direction in the illustration represents the sub-scanning direction (lateral direction).

As described above, the erecting equal-magnification lens array plate 11 is formed as a stack of the first lens array plate 24 and the second lens array plat 26. Each of the first lens array plate 24 and the second lens array plate 26 is a rectangular plate having a thickness t and is provided with an arrangement of a plurality of convex lenses on both sides thereof. Specifically, a systematic arrangement of a plurality of first lenses 24a is formed on a first surface 24c of the first lens array plate 24, and a systematic arrangement of a plurality of second lenses 24b is formed on a second surface 24d opposite to the first surface 24c. A systematic arrangement of a plurality of third lenses 26a is formed on a third surface 26c of the second lens array plate 26, and a systematic arrangement of a plurality of fourth lenses 26b is formed on a fourth surface 26d opposite to the third surface 26c. In this embodiment, it is assumed that the first lens 24a, the second lens 24b, the third lens 26a, and the fourth lens 26b are spherical in shape. Alternatively, the lenses may have aspherical shapes.

The first lens array plate 24 and the second lens array plate 26 are formed by injection molding. Preferably, each of the first lens array plate 24 and the second lens array plate 26 is formed of a material amenable to injection molding, having high light transmittance in a desired wavelength range, and having low water absorption. Desired materials include cycloolefin resins, olefin resins, norbornene resins, and polycarbonate.

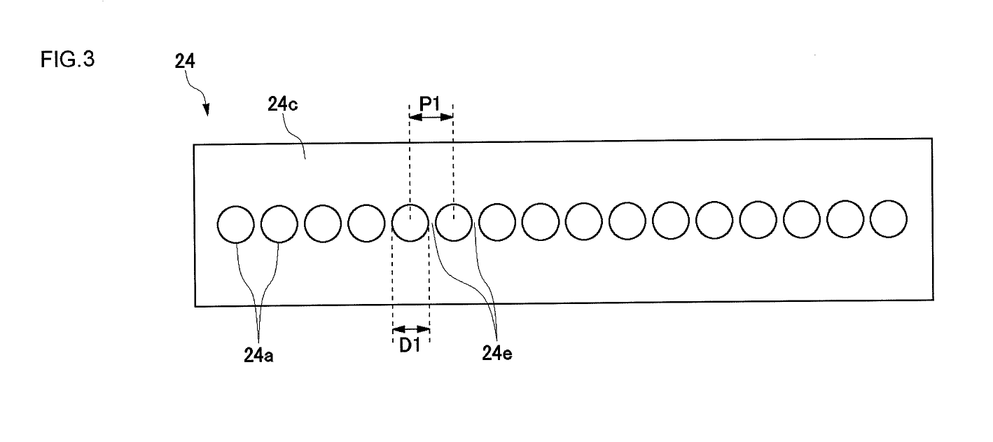

FIG. 3 is a top view showing the first surface 24c of the first lens array plate 24. As shown in FIG. 3, the plurality of first lenses 24a are arranged in a single line on the first surface 24c at a lens pitch P1 along the longitudinal direction of the first lens array plate 24. The lens diameter D1 of the first lens 24a is configured to be smaller than the lens pitch P1. Therefore, a first flat part 24e not formed with a lens is provided between the adjacent first lenses 24a.

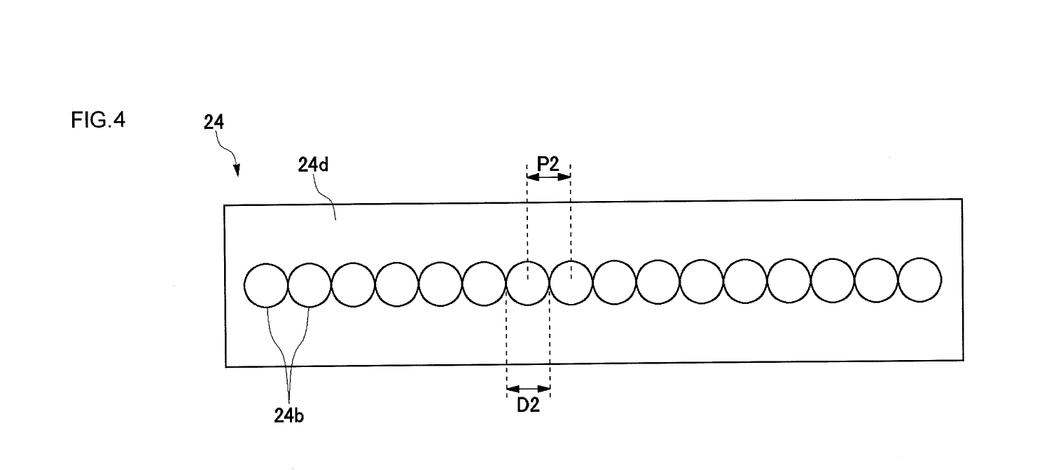

FIG. 4 is a top view showing the second surface 24d of the first lens array plate 24. As shown in FIG. 4, the plurality of second lenses 24b are arranged in a single line on the second surface 24d at a lens pitch P2 along the longitudinal direction of the first lens array plate 24. The lens pitch P2 of the second lenses 24b is identical to the lens pitch P1 of the first lenses 24a. The lens diameter D2 of the second lens 24b is configured to be identical to the lens pitch P2. Therefore, the adjacent second lenses 24b are in contact with each other at their edges. In other words, the second lenses 24b on the second surface 24d of the first lens array plate 24 are formed so as to create no gaps between the adjacent lenses.

The third lenses 26a are arranged in a single line on the third surface 26c of the second lens array plate 26 at a lens pitch P3 along the longitudinal direction of the second lens array plate 26. The fourth lenses 26b are arranged in a single line on the fourth surface 26d of the second lens array plate 26 at a lens pitch P4 along the longitudinal direction of the second lens array plate 26. The lens pitch P2 and the lens pitch P3 are equal to the lens pitch P1 of the first lenses 24a. The lens diameter D3 of the third lens 26a and the lens diameter D4 of the fourth lens 26b are equal to the lens diameter D1 of the first lens 24a. Since the lens diameter D1 is smaller than the lens pitch P1, a third flat part 26e is provided between the adjacent third lenses 26a and a fourth flat part 26f is provided between the adjacent fourth lenses 26b, as shown in FIG. 2.

The first lens array plate 24 and the second lens array plate 26 formed with the lenses as described above form a stack such that the second surface 24d and the third surface 26c face each other to ensure that a combination of the first lens 24a, second lens 24b, third lens 26a, and fourth lens 26b associated with each other form a coaxial lens system.

As described above, the first lens array plate 24 and the second lens array plate 26 are held by a holder 30 in a stacked state. As shown in FIG. 1, the holder 30 is formed as a hollow quadrangular prism. The first lens array 24 and the second lens array plate 26 are inserted therein. Alternatively, the hollow quadrangular prism may be divided into two parts so that the two parts accommodate the first lens array plate 24 and the second lens array plate 26, respectively. A plurality of first through holes 30c corresponding to the plurality of first lenses 24a of the first lens array plate 24 are formed in the first surface part 30a of the holder 30. A plurality of second through holes 30d corresponding to the plurality of second lenses 26b of the second lens array plate 26 are formed in the second surface part 30b of the holder 30 opposite to the first surface part 30a. The first through holes 30c and the second through holes 30d are cylindrical through holes.

The first through holes 30c and the second through holes 30d have the same shape and are arranged in a line at the same pitch along the longitudinal direction of the first surface part 30a and the second surface part 30b, respectively. The central axes of the corresponding two through holes are aligned. The diameter of each of the first through holes 30c and the second through holes 30d is configured to be substantially the same as or slightly smaller than the diameter D1 of the first lenses 24a and the fourth lenses 26b. The pitch of arrangement of the first through holes 30c and the second through holes 30d is identical to the lens pitch P1 of the first lenses 24a and the fourth lenses 26b.

The first surface part 30a and the second surface part 30b of the holder 30 are formed as one piece using a light shielding material. The assembly may be formed by, for example, injection molding. Preferably, the shielding material is amenable to injection molding and is highly capable of shielding light in a required wavelength band. For example, the shielding material may be a black ABS resin.

In a state where the first lens array plate 24 is inserted into the holder 30, the plurality of first lenses 24a are laid in the respective first through holes 30c of the first surface part 30a. Further, in a state where the second lens array plate 26 is inserted into the holder 30, the plurality of fourth lenses 26b are laid in the respective second through holes 30d of the second surface part 30b.

By producing the assembly as described above, the area on the first surface 24c of the first lens array plate 24 outside the first lenses 24a is covered by the first surface part 30a of the holder 30. Further, the area on the fourth surface 26d of the second lens array plate 26 outside the fourth lenses 26b is covered by the second surface part 30b of the holder 30.

The first surface part 30a and the second surface part 30b of the holder 30 are formed by using a light shielding material. Accordingly, the portion of the first surface part 30a surrounding the first lens 24a functions as a first light shielding wall 30e that prevents stray light from being incident on the first lens 24a. The portion of the second surface part 30b surrounding the fourth lens 26b functions as a second light shielding wall 30f that prevents stray light from being exited from the second lens 24b.

By adjusting the thickness of the first surface part 30a and the second surface part 30b of the holder 30, the height of the first light shielding wall 30e and the second light shielding wall 30f can be changed. The height of the first light shielding wall 30e and the second light shielding wall 30f is set to remove light entering at an angle larger than a predetermined maximum angle of view.

The erecting equal-magnification lens array plate 11 as configured above is built in the image reading device 100 such that the distance from the first lens 24a to the document G and the distance from the fourth lens 26b to the line image sensor 20 are equal to a predetermined working distance WD. In this embodiment, the distance from the first light shielding wall 30e on the first surface 24c to the document G and the distance from the second light shielding wall 30f on the fourth surface 26d to the line image sensor 20 will be referred to as an effective working distance WD′.

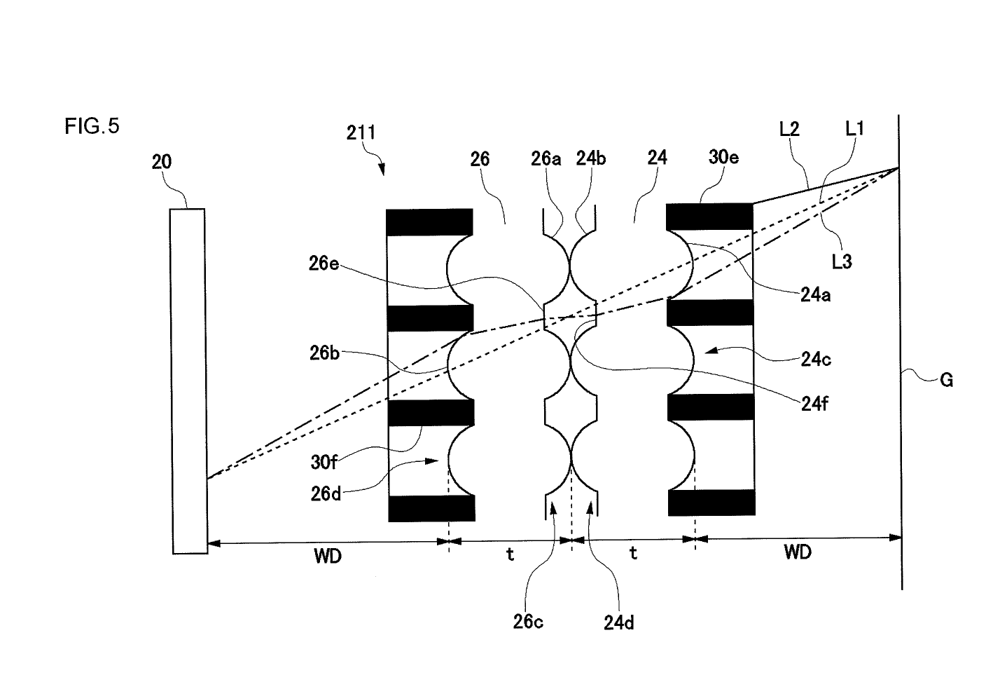

A description will now be given of the operation of the erecting equal-magnification lens array plate 11 according to the embodiment. Before describing the operation of the erecting equal-magnification lens array plate 11, a comparative example will be shown. FIG. 5 shows the operation of an erecting equal-magnification lens array plate 211 according to a comparative example. In the erecting equal-magnification lens array plate 211 according to the comparative example, the lens diameter D2 of the second lens 24b is configured to be equal to the lens diameter D1 of the first lens 24a. The other aspects of the structure of the erecting equal-magnification lens array plate 211 are the same as the corresponding aspects of the erecting equal-magnification lens array plate 11 shown in FIG. 2.

It will be assumed that a light beam outside the maximum angle of view enters one of the first lenses 24a of the erecting equal-magnification lens array plate 211. As shown in FIG. 5, the light beam traveling toward the lens center of the first lens 24a will be referred to as primary light beam L1 (dotted line), and the light beam traveling toward one of the edges of the first lens 24a will be denoted by L2 (solid line), and the light beam traveling toward the other edge of the first lens 24a will be denoted by L3 (dashed line).

As shown in FIG. 5, the light beam L2 is removed by the first light shielding wall 30e. The primary light beam L1 and the light beam L3 are incident on the first lens 24a, travel past the second flat part 24f of the second surface 24d and the third flat part 26e of the third surface 26c, respectively, before exiting the fourth lens 26b of the lens system adjacent to the lens system to which the first lens 24a on which the beams are incident belongs. The light exiting the fourth lens 26b is not removed by the second light shielding wall 30f and is incident on the line image sensor 20, creating noise.

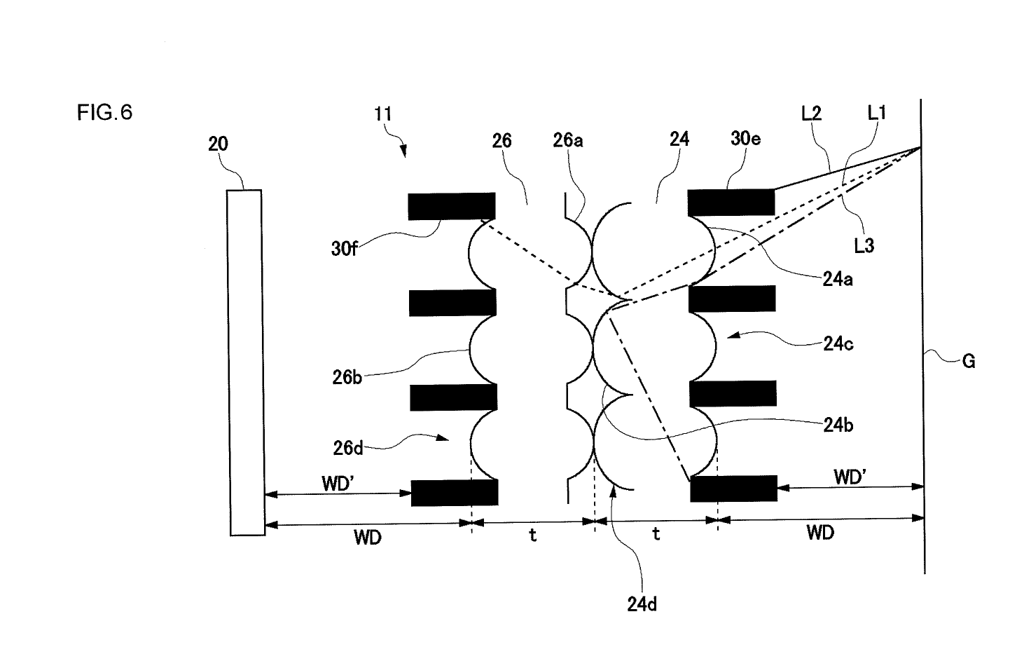

FIG. 6 shows the operation of an erecting equal-magnification lens array plate 11 according to the embodiment. Like in FIG. 5, it will be assumed that a light beam outside the maximum angle of view enters one of the first lenses 24a of the erecting equal-magnification lens array plate 11. The light beam traveling toward the lens center of the first lens 24a will be referred to as primary light beam L1 (dotted line), and the light beam traveling toward one of the edges of the first lens 24a will be denoted by L2 (solid line), and the light beam traveling toward the other edge of the first lens 24a will be denoted by L3 (dashed line).

As shown in FIG. 6, the light beam L2 is removed by the first light shielding wall 30e. The primary light beam L1 and the light beam L3 are incident on the first lens 24a. Since the second lenses 24b on the second surface 24d are arranged so as to create no gaps between the adjacent lenses, the primary light beam L1 is refracted by the second lens 24b of the lens system to which the first lens 24a on which the beam is incident belongs. The primary light beam L1 is then incident on the second lens array plate 26 and is removed by the second light shielding wall 30f. The light beam L3 is totally reflected by the second lens 24b of the lens system adjacent to the lens system to which the first lens 24a on which the beam is incident belongs.

Thus, since the second lenses 24b on the second surface 24d of the erecting equal-magnification lens array plate 11 according to the embodiment are arranged so as to create no gaps between the adjacent lenses, at least a part of the beam diagonally incident from the document G on the first lens array plate 24 is totally reflected or refracted by the boundary division of the second lenses 24b. The beam totally reflected or refracted is removed by the first light shielding wall 30e or the second light shielding wall 30f. This prevents stray light from being incident on the line image sensor 20 more properly than in the erecting equal-magnification lens array plate 211 according to the comparative example of FIG. 5. Accordingly, a high-quality erect equal-magnification image with reduced noise can be formed.

If the diagonally incident primary light beam L1 and light beam L3 are to be removed in the erecting equal-magnification lens array plate 211 according to the comparative example of FIG. 5, light shielding members that cover the second flat part 24f of the second surface 24d and the third flat part 26e of the third surface 26c should be provided. The erecting equal-magnification lens array plate 11 according to the embodiment does not require such light shielding members so that the number of components is reduced and the manufacturing cost is reduced.

The erecting equal-magnification lens array plate 11 according to the embodiment is configured such that light shielding walls are formed both on the first surface 24c and the fourth surface 26d. When light shielding walls are formed both on the first surface 24c and the fourth surface 26d, the light beams entering the lens at angles greater than the maximum angle of view are removed by using one of the light shielding walls to remove those beams outside the primary beam that enters the lens center. Thus, the height of the light shielding wall can be smaller than in the case of providing light shielding walls only on one surface. In this way, a large effective working distance WD′ is secured. The maximum effective working distance WD′ is secured by ensuring that the light shielding walls on the first surface 24c and on the fourth surface 26d have the same light shielding capability, i.e, by ensuring that the light shielding walls on the first surface 24c and on the fourth surface 26d have the same height.

It is desirable to secure as large effective working distance WD′ as possible in building the erecting equal-magnification lens array plate 11 into the optical scanning unit 10. By securing a large effective working distance WD′, the glass plate 14 is prevented from being in contact with the erecting equal-magnification lens array plate 11 even when the glass plate 14 carrying the document G is bent or when the optical scanning unit 10 is vibrated.

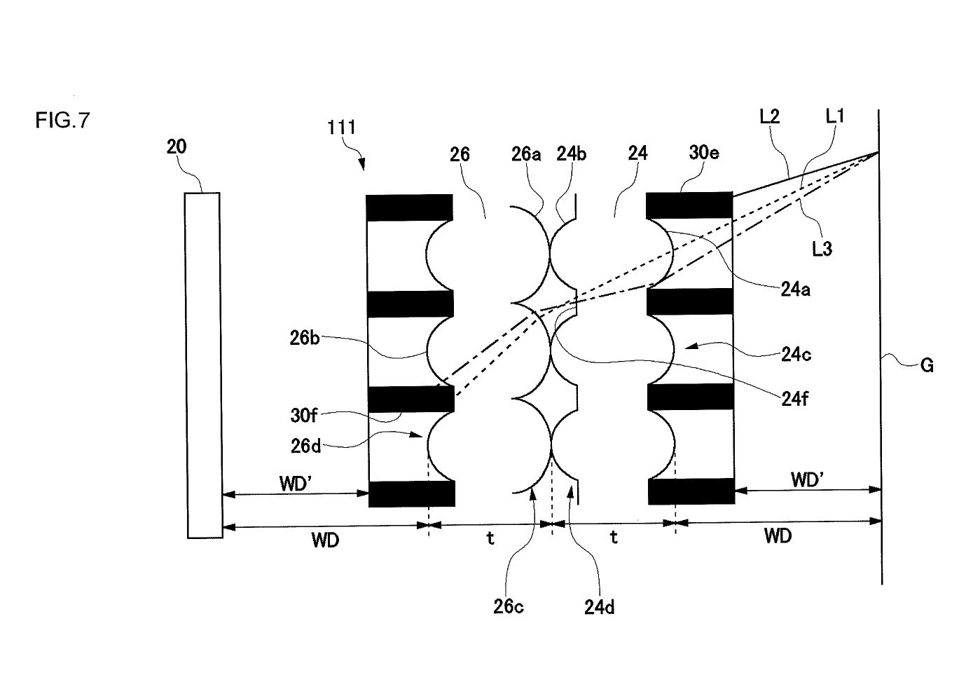

FIG. 7 shows an erecting equal-magnification lens array plate 111 according to another embodiment of the present invention. In the erecting equal-magnification lens array plate 111, the lens diameter D3 of the third lens 26a on the third surface 26c of the second lens array plate 26 is configured to be equal to the lens pitch P3 of the third lenses 26a. Therefore, the adjacent third lenses 26a are in contact with each other at their edges. In other words, the third lenses 26a on the third surface 26c of the second lens array plate 26 are formed so as to create no gaps between the adjacent lenses. The lens diameter D2 of the second lens 24b of the first lens array plate 24 is configured to be smaller than the lens pitch P2 of the second lenses 24b. Therefore, a second flat part 24f not formed with a lens is provided between the adjacent second lenses 24b.

A description will now be given of the operation of the erecting equal-magnification lens array plate 111 according to the embodiment. Like in FIGS. 5 and 6, it will be assumed that a light beam outside the maximum angle of view enters one of the first lenses 24a of the erecting equal-magnification lens array plate 111. The light beam traveling toward the lens center of the first lens 24a will be referred to as primary light beam L1 (dotted line), and the light beam traveling toward one of the edges of the first lens 24a will be denoted by L2 (solid line), and the light beam traveling toward the other edge of the first lens 24a will be denoted by L3 (dashed line).

As shown in FIG. 7, the light beam L2 is removed by the first light shielding wall 30e. The primary light beam L1 and the light beam L3 are incident on the first lens 24a. The primary light beam L1 and the light beam L3 are incident on the second lens array plate 26 via the second flat part 24f on the second surface 24d. Since the third lenses 26a on the third surface 26c according to this embodiment are arranged so as to create no gaps between the adjacent lenses, the primary light beam L1 and the light beam L3 are incident on the third lens 26a of the lens system adjacent to the lens system to which the first lens 24a on which the beam is incident belongs. The primary light beam L1 and the light beam L3 are refracted by the third lens 26a and are removed by the second light shielding wall 30f on the fourth surface 26d.

Thus, by configuring the third lenses 26a to create no gaps between the adjacent lenses, stray light is suitably removed and a high-quality erect equal-magnification image with reduced noise can be formed. As in the erecting equal-magnification lens array plate 11 shown in FIG. 2, a large effective working distance WD′ is secured by forming light shielding walls both on the first surface 24c and the fourth surface 26d.

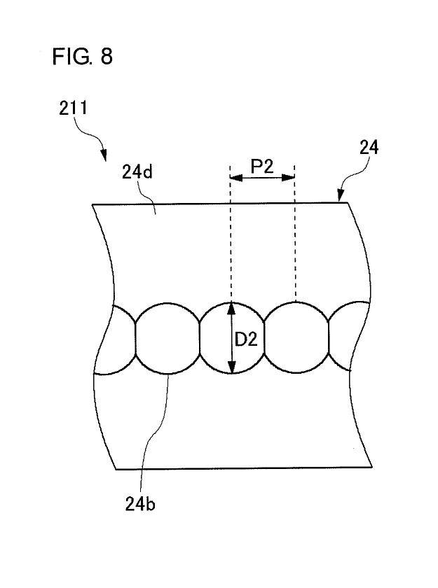

FIG. 8 shows an erecting equal-magnification lens array plate 211 according to yet another embodiment of the present invention. FIG. 8 is an enlarge top view showing an important part of the second surface 24d of the first lens array plate 24. As in the foregoing embodiments, the plurality of second lenses 24b having the lens diameter D2 are arranged in a single line on the second surface 24d at the lens pitch P2 along the longitudinal direction of the first lens array plate 24.

In this embodiment, the second lenses 24b are arranged such that the lens pitch P2 is smaller than the lens diameter D2. Therefore, the edges of the adjacent second lenses 24b overlap each other. As in the erecting equal-magnification lens array plate 11 shown in FIG. 2, the first, third, and fourth lenses are arranged on the first, third, and fourth surfaces, respectively, such that a flat part is located between the adjacent lenses.

By arranging the second lenses 24b such that the edges of the adjacent second lenses 24b overlap each other and eliminating gaps between the adjacent second lenses 24b accordingly, as in this embodiment, stray light is suitably removed as in the erecting equal-magnification lens array plate 11 shown in FIG. 2.

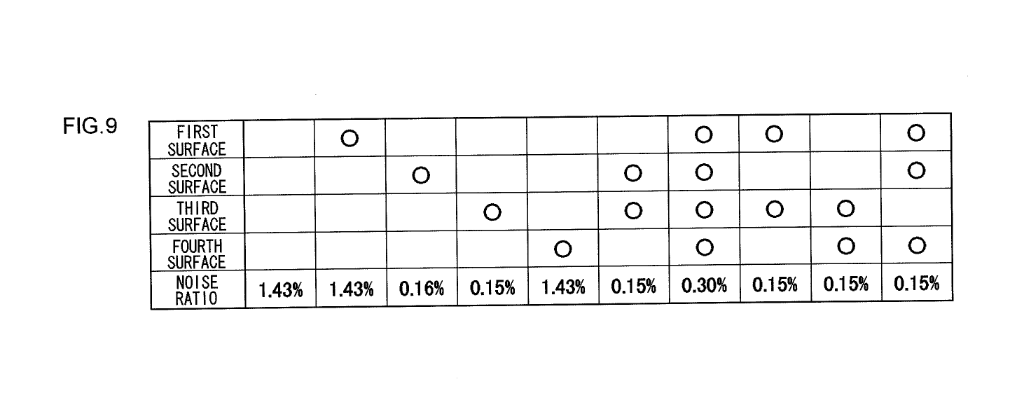

FIG. 9 shows how the noise ratio varies as the lens diameter of the first through fourth surfaces is varied. A ray tracing simulation was conducted. The erecting equal-magnification lens array plate 11 is illuminated in the main scanning direction by a 90° Lambertian emission from a point light source. The amount of imaging light arriving at a specified point on the image plane is designated as the amount of imaging light transmitted. The amount of light arriving elsewhere is designated as the amount of light transmitted as noise. The illumination and measurement are conducted on a line extending in the main scanning direction. A noise ratio is defined as a sum of the amount of light transmitted as noise divided by the amount of imaging light transmitted. The evaluation is based on the principle of reversibility of light-path. The sensor represents the light source and the document represents the image plane.

The conditions of simulation are such that the lenses are arranged in a single line, the lens's working distance WD=3.3 mm, the plate thickness t of the first and second lens array plates is such that t=1.65 mm, the lens pitch=0.65 mm, the standard lens diameter=0.6 mm, the refractive index n=1.53, the height of the first and second light shielding walls=0.7 mm, the hole diameter (lens aperture) of the first and second through holes=0.5 mm, the lens's curvature radius=0.4 mm, and the TC conjugation length=9.9 mm. The standard lens diameter is 0.6 mm. The lens surface where the lens diameter is changed to 0.8 mm is indicated by a circle in the figure. For example, the rightmost column indicates that the lens diameter of the first, second and fourth surfaces is 0.8 mm, and the lens diameter of the third surface is 0.6 mm. Since the lens pitch is 0.65 mm, there is not a gap between the adjacent lenses as shown in FIG. 8 if the lens diameter is 0.8 mm. The edges of the lenses overlap each other.

Referring to FIG. 9, a significantly high noise ratio of 1.43% occurs when the lens diameter of the first through fourth surfaces is 0.6 mm, when the lens diameter of only the first surface is 0.8 mm, or when the lens diameter of only the fourth surface is 0.8 mm. In contrast, a significantly low noise ratio of less than 0.16% is achieved when the lens diameter of the second or the third surfaces is 0.8 mm irrespective of the lens diameter of the first or fourth surfaces. A significantly low noise ratio of 0.15% is achieved when the lens diameter of only the second and third surfaces is 0.8 mm. When the lens diameter of the first through fourth surfaces is 0.8 mm, a slightly poor noise ratio of 0.3% occurs. The result of simulation indicates that the noise ratio is reduced by designing the lens diameter of the second and/or the third surface is equal to or more than the lens pitch and eliminating gaps between the adjacent lenses.

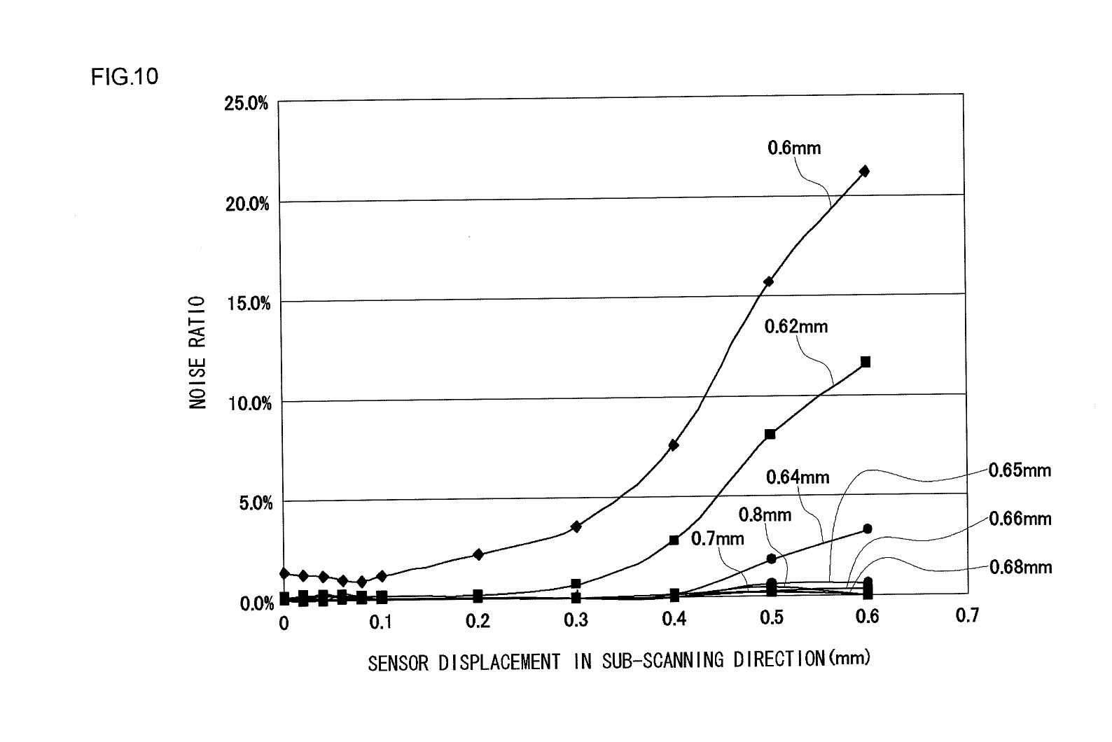

FIG. 10 shows how the noise ratio varies as the lens diameter is varied. The lens diameter of the first and fourth surfaces is set to 0.6 mm, and the lens diameter of the second and third surfaces is varied in the range 0.6 mm-0.8 mm. In order to examine how the noise ratio varies in the presence of displacement in the line image sensor, a ray tracing simulation is performed by providing the line image sensor displacement in the range 0 mm-0.6 mm in the sub-scanning direction. The parameters other than the lens diameter are the same as those of the simulation of FIG. 9.

Referring to FIG. 10, given the displacement of 0.6 mm of the line image sensor, the noise ratio is maintained at 1% or lower by ensuring that the lens diameter of the second and third surfaces is 0.65 mm or more. In other words, the noise ratio is reduced by ensuring that the lens diameter of the second and third surfaces is equal to or more than the lens pitch. By maintaining the noise ratio at a low level even when the line image sensor is displaced in the sub-scanning direction, a large tolerance for assembling the erecting equal-magnification lens array plate and the line image sensor is secured. As a result, the optical scanning unit can be built with ease and the manufacturing cost is reduced.

Referring further to FIG. 10, given the 0 mm displacement of the line image sensor, the noise ratio is maintained at 0.5% or less by ensuring that the lens diameter of the second and third surfaces is 0.62 mm or more. In other words, the noise ratio is reduced not only when there are no absolutely gaps between the adjacent lenses but also when the gap is extremely small such that the ratio of the lens diameter with respect to the lens pitch is, for example, 0.62 mm/0.65 mm=0.95 or more.

Given above is an explanation of the present invention based on an embodiment. The embodiment is intended to be illustrative only and it will be obvious to those skilled in the art that various modifications to constituting elements and processes could be developed and that such modifications are also within the scope of the present invention.

In the embodiments described above, the lenses on the respective surfaces are arranged in a single line in the main scanning direction. The pattern of arranging the lenses is not non-limiting. For example, the lenses may be arranged in two lines in the main scanning direction or arranged in a square.

In the embodiments described above, the holder holding the first lens array plate and the second lens array plate is used to form the light shielding walls on the first and fourth surfaces. Alternatively, light shielding walls may be formed directly on the first and fourth surfaces. For example, a light shielding wall may be formed by coating the first and fourth surfaces with a stack of black resin paint.

What is claimed is:

1. An erecting equal-magnification lens array plate comprising:
a first lens array plate provided with a plurality of first lenses arranged systematically on a first surface of the plate and with a plurality of second lenses arranged systematically on a second surface opposite to the first surface; and
a second lens array plate provided with a plurality of third lenses arranged systematically on a third surface of the plate and with a plurality of fourth lenses arranged systematically on a fourth surface opposite to the third surface,
wherein the first lens array plate and the second lens array plate form a stack such that the second surface and the third surface face each other to ensure that a combination of the lenses associated with each other form a coaxial lens system, the plate receiving light from a line light source facing the first surface and forming an erect equal-magnification image of the line light source on an image plane facing the fourth surface,
wherein the second lenses and/or the third lenses are arranged so as to create no gaps between adjacent lenses.

2. The erecting equal-magnification lens array plate according to claim 1,
wherein the second lenses and/or the third lenses are formed such that the lens diameter is equal to or more than the lens pitch.

3. The erecting equal-magnification lens array plate according to claim 1,
wherein a light shielding wall for removing stray light is provided on the first and fourth surfaces.

4. An optical scanning unit comprising:
a line light source adapted to illuminate an image to be read;
the erecting equal-magnification lens array plate according to claim 1 adapted to condense light reflected from the image to be read; and
a line image sensor adapted to receive the light transmitted by the erecting equal-magnification lens array plate.

5. An image reading device comprising:
the optical scanning unit according to claim 4; and an image processing unit adapted to process an image signal detected by the optical scanning unit.

6. An erecting equal-magnification lens array plate comprising:
a first lens array plate provided with a plurality of first lenses arranged systematically on a first surface of the plate and with a plurality of second lenses arranged systematically on a second surface opposite to the first surface; and
a second lens array plate provided with a plurality of third lenses arranged systematically on a third surface of the plate and with a plurality of fourth lenses arranged systematically on a fourth surface opposite to the third surface,
wherein the first lens array plate and the second lens array plate form a stack such that the second surface and the third surface face each other to ensure that a combination of the lenses associated with each other form a coaxial lens system, the plate receiving light from a line light source facing the first surface and forming an erect equal-magnification image of the line light source on an image plane facing the fourth surface, wherein
the second lenses and/or the third lenses are formed such that the ratio of the lens diameter with respect to the lens pitch is 0.95 or more.

7. The erecting equal-magnification lens array plate according to claim 6,
wherein a light shielding wall for removing stray light is provided on the first and fourth surfaces.

8. An optical scanning unit comprising:
a line light source adapted to illuminate an image to be read;
the erecting equal-magnification lens array plate according to claim 6 adapted to condense light reflected from the image to be read; and
a line image sensor adapted to receive the light transmitted by the erecting equal-magnification lens array plate.

9. An image reading device comprising:
the optical scanning unit according to claim 8; and
an image processing unit adapted to process an image signal detected by the optical scanning unit.
